(19) United States
(12) Patent Application Publication
(10) Pub. No.: US 2014/0011192 A1
(43) Pub. Date: Jan. 9, 2014

(54) PARTICLE COMPLEX AND METHOD OF ISOLATING TARGET CELL

(71) Applicant: SAMSUNG ELECTRONICS CO., LTD., Suwon-si (KR)

(72) Inventors: Hun-joo LEE, Hwaseong-si (KR); Jin-mi OH, Suwon-si (KR); Soo-suk LEE, Suwon-si (KR); Jeong-gun LEE, Seoul (KR)

(73) Assignee: SAMSUNG ELECTRONICS CO., LTD., Suwon-si (KR)

(21) Appl. No.: 13/774,887

(22) Filed: Feb. 22, 2013

(30) Foreign Application Priority Data
Jul. 9, 2012 (KR) 10-2012-0074692

(51) Int. Cl. G01N 21/64

(52) U.S. Cl. CPC G01N 21/6486
USPC 435/6.1; 530/391.1; 536/23.1; 435/7.23

(57) ABSTRACT

A particle complex comprising a particle; a cleavable linker bound to a surface of the particle; and a macromolecule bound to the cleavable linker, wherein the macromolecule specifically binds to a surface marker of a target cell, and a method of isolating a target cell comprising same.

### CROSS-REFERENCE TO RELATED APPLICATIONS

This application claims the benefit of Korean Patent Application No. 10-2012-0074692, filed on Jul. 9, 2012, in the Korean Intellectual Property Office, the entire disclosure of which is incorporated herein by reference.

### BACKGROUND

1. Field

The present disclosure relates to a particle complex for target cell isolation, and a method of isolating a target cell by using the particle complex.

2. Description of the Related Art

Cells are the basic unit of the human body, and have different shapes in different organs. Tissue diseases may mostly be diagnosed via tissue biopsy tests, and more recently, more convenient and accurate cell tests have become possible. Many patients may attain more accurate diagnosis results through cell tests without having to take unnecessary tissue tests, so that cell tests are increasingly considered to be significant.

Cells in solid tissues may be isolated via microscopic observation of their locations, while cells in body liquids, and in particular, cells in blood, may not be selectively isolated because blood is a complex of a variety of cells. Isolating only a target cell from a sample, like blood, containing a variety of cells with different characteristics, or removing unwanted cells from the sample, is essential for a cell count, understanding shapes and characteristics of the cells, identifying specificity of surface or internal proteins of the cells via immunoassay, single cell analysis, and gene analysis.

Recently, research into blood cancer cells is being actively conducted. Death from malignant tumors is mostly caused from metastasis of the tumor from the onset site to a separate tissue or organism. Thus, early detection of metastasis is a crucial factor for the survival probability of cancer patients, and early detection of tumors and monitoring of tumor growth are considered to be highly significant for successful treatment of cancer patients. Cancer diagnosis is generally based on histopathology-based techniques. Histopathology-based diagnosis techniques are methods of diagnosing tumors by using a bioptic tissue sample. This histopathology-based approach in tumor diagnosis involves direct observation of tumor cells. However, it may be uncertain if a tumor is in a tissue selected for a biopsy sample. Furthermore, only data on the specific site from which the biopsy sample is taken is available, so that occurrence of metastasis to other sites is not identified. Thus, the histopathology-based approach has limited applicability, and is not suitable to diagnose or monitor tumors.

Circulating tumor cells (CTCs) are extremely rarely occurring cells in the bloodstream that may indicate whether a patient has cancer with high likelihood of becoming metastatic. Accurate and early detection of CTCs has been considered a potentially powerful tool in cancer prognosis, diagnosis of minimal residual disease, assessment of tumor sensitivity to drugs, and personalization of anti-cancer therapy. In view of the fact that cancer metastasis normally occurs through blood, CTCs may serve as an index of cancer metastasis. CTCs are also often found even after surgery to remove cancer cells, indicating probability of cancer recurrence. However, these CTCs in blood are very few in numbers and are weak, and thus detecting CTCs and the number thereof is difficult. Therefore, there is still a demand for a high-sensitivity diagnosis method for detecting CTCs, cancer cells, or cancer stem cells in a patent's body, an efficient method of isolating tumor cells from a biological sample, and an apparatus for use with respect to these methods. For these reasons, the significance of CTC isolation technologies is increasingly considered in CTC analysis, medical research, pharmaceutical research, and disease diagnosis, and thus application fields thereof are currently widening.

### SUMMARY

Provided is a particle complex comprising: (a) a particle; (b) a cleavable linker bound to a surface of the particle; and (c) a macromolecule bound to the cleavable linker, wherein the macromolecule specifically binds to a surface marker of a target cell.

Provided is a method of isolating a target cell by using the particle complex comprising: (a) contacting the particle complex with a biological sample including the target cell; (b) isolating the particle complex specifically bound to the target cell; and (c) cleaving the cleavable linker in the particle complex, thereby resulting in a target cell-including moiety and a particle-including moiety.

### BRIEF DESCRIPTION OF THE DRAWINGS

These and/or other aspects will become apparent and more readily appreciated from the following description of the embodiments, taken in conjunction with the accompanying drawings.

FIG. 1 is a schematic view of a particle complex for isolating a target cell, according to an embodiment of the present invention.

FIG. 2 is a graph of fluorescence intensity with respect to a coverage ratio of the particle complex according to an embodiment of the present invention, which is specifically bound to surfaces of breast cancer cells. The percent signal intensity change ratio is on the y-axis and the percent bead coverage is on the x-axis.

FIG. 3 is a graph illustrating a result of removing, by exposure to light, the particle complex according to an embodiment of the present invention from the breast cancer cell bound with the particle complex. The percent melamine bead coverage (y-axis) before and after light exposition (x-axis) is illustrated.

FIG. 4 illustrates fluorescence images of the breast cancer cells, comparatively showing fluorescent intensities when the breast cancer cells were unbound or bound with the particle complex according to an embodiment of the present invention or after the particle complex was removed therefrom by exposure to light.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

According to an aspect of the present invention, there is provided a particle complex comprising, consisting essentially of, or consisting of (a) a particle, (b) a cleavable linker bound to a surface of the particle, and (c) a macromolecule bound to the cleavable linker, wherein the macromolecule is capable of specifically binding to a surface marker of a target cell.

In some embodiments, the particle complex may be used for isolating the target cell.

The term “target cell”, which means a cell to be isolated from a biological sample, may be a cell with a surface marker on a surface of the cell. Non-limiting examples of the target cell are circulating tumor cells (CTCs), cancer stem cells, immune cells, fetal stem cells, fetal cells, cancer cells, tumor cells, and a combination thereof.

The term “surface marker” may be any material present on the surface of the target cell that is able to distinguish the target cell from other neighboring cells. Non-limiting examples of the surface marker are proteins, sugars, lipids, nucleic acids, and a combination thereof. In some embodiments, the surface marker may be a protein specifically expressed in a target cell and exhibited in a cell membrane. Non-limiting examples of the surface marker are estrogen receptors, progesterone receptors, synaptophysin, mucin 1 (MUC1), Bcl-2, MIB1/Ki67, cyclin D1, cyclin E, p27, topoisomerase Ila, cyclooxygenase 2, ERK1/ERK2, phosphor-S6 ribosomal protein, CK5, CK8, CK17, vimentin, epithelial cell adhesion molecules (EpCAM), c-Met, cytokeratines, Her2, EGFR, p53, p63, E-cadherin, fragile histidine triad, protein tyrosine phosphatase, β-catenin, p16, c-kit, endothelin-1, endothelin receptor-α, endothelin receptor-β, chemokine (C×C motif) receptor 4, breast cancer resistance protein, ABCA3, MGMT, and a combination thereof.

The term “specifically binding” has a generic meaning used in the art, and means, for example, binding of an antibody and an antigen, or an aptamer and a protein, via a specific interaction. In some embodiments, the macromolecule may be an antibody or an aptamer.

In one embodiment, the macromolecule is an antibody or an antigen binding fragment thereof. The antibody or the antigen binding fragment thereof may be a heavy or light chain of an antibody or antigen-binding antibody fragment selected from the group consisting of a Fab fragment, a Fab′ fragment, an Fv fragment, and an scFv fragment, or a single-domain antibody, but not limited thereto. An intact antibody includes four polypeptides: two full-length light chains and two full-length heavy chains, in which each light chain is linked to a heavy chain by disulfide bonds (SS-bond). The antibody has a constant region: a heavy chain constant region and a light chain constant region. There are five heavy chain classes (isotypes): gamma (γ), mu (μ), alpha (α), delta (δ), or epsilon (ε), and additionally several subclasses: gamma 1 (γ1), gamma 2(γ2), gamma 3(γ3), gamma 4(γ4), alpha 1(α1), or alpha 2(α2). The light chain constant region is either kappa (k) or lambda (λ) type.

The term “antigen binding fragment(s)” used herein refers to fragments of an intact immunoglobulin, and any part of a polypeptide including antigen binding regions. For example, the antigen binding fragment may be a F(ab′)₂ fragment, a Fab′ fragment, a Fab fragment, an Fv fragment, an scFv fragment, or a single-domain antibody, but is not limited thereto. A Fab fragment has one antigen binding site and contains the variable regions of a light chain and a heavy chain, the constant region of the light chain, and the first constant region C_{H1} of the heavy chain. A Fab′ fragment is different from the Fab fragment in that the Fab′ fragment additionally includes the hinge region of the heavy chain, including at least one cysteine residue at the C-terminus of the heavy chain C_{H1} region. A F(ab′)₂ fragment is produced whereby cysteine residues of the Fab′ fragment are joined by a disulfide bond at the hinge region. An Fv fragment is a minimal antibody fragment having only heavy chain variable regions and light chain variable regions, and a recombinant technique for producing the Fv fragment is well known in the art. Two-chain Fv fragments may have a structure in which heavy chain variable regions are linked to light chain variable regions by a non-covalent bond. Single-chain Fv fragments generally may have a dimer structure as in the two-chain Fv fragments in which heavy chain variable regions are covalently bound to light chain variable regions via a peptide linker or heavy and light chain variable regions are directly linked to each other at the C-terminus thereof. The antigen binding fragment may be obtained using a protease (for example, a whole antibody is digested with papain to obtain Fab fragments, or is digested with pepsin to obtain F(ab′)₂ fragments), and may be prepared by a genetic recombinant technique. A single-domain antibody (sdAb) is an antibody fragment consisting of a single, monomeric, variable antibody domain, such as the variable heavy domain (V_{H}). Single-domain antibodies typically have a very low molecular weight (generally about 12-15 kDa, but not limited thereto).

In some embodiments, the particle complex may include a cleavable linker bound to a particle surface thereof.

The target cell specifically bound to the particle complex may be divided into a target cell-including moiety and a particle-including moiety when the cleavable linker is cleaved, so that the particle-including moiety may be removed for subsequent experiments, such as surface observation on the target cells, immunoassays, in-situ hybridization, and the like.

In some embodiments, the cleavable linker may include a photocleavable compound (i.e., a photocleavable group or moiety). The photocleavable compound can be any compound that can be cleaved by light. For instance, the photocleavable compound can contain a 2-nitrobenzyl group and a (coumarin-4-yl)methyl group, but is not limited thereto.

In some embodiments, the particle may be surface-coated with an anti-adsorption agent. The anti-adsorption agent can be any agent that, when applied to the surface of the particle, reduces non-specific adsorption of macromolecules or other biological materials to the surface of the particle, including non-specific adsorption or adhesion of the particle to the surface of a target cell. Non-limiting examples of the anti-adsorption agent are hydrophilic polymers, such as polyethylene glycol (PEG), BSA, casein, and serum proteins.

In some embodiments, the particle complex may further include a protein connecting the cleavable linker and the macromolecule. Examples of the protein include, but are not limited to, proteins selected from the group consisting of protein G, protein L, protein A, protein LA, protein AG, and a combination thereof. . In one embodiment, the protein is a microorganism-originating protein binding to a heavy-chain constant region of immunoglobulin and may be used for purifying antibodies. For example, the protein may link the cleavable linker and the antibody to direct an antibody-binding site of the antibody toward the surface marker of the target cell.

In some embodiments, the particle may be selected from the group consisting of polymer particles (e.g., latex particles), silica particles, metal particles, glass particles, magnetic particles, and particles comprising a combination of such materials, but is not limited thereto.

The target cell may be specifically isolated from the biological sample with a high purity in a variety of ways depending on the characteristics of the particles (for example, magnetism, density, and size of the particles).

In some embodiments, the particle may have any of a variety of diameters depending on the size of the target cell to be isolated. For example, the particular can have a diameter of from about 10 nm to about 10 μm (e.g., 25 nm, 50 nm, 75 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 1 μm, 2 μm, 3 μm, 4 μm, 5 μm, 6 μm, 7 μm, 8 μm, or 9 μm including ranges thereof), a diameter of from about 100 nm to about 5 μm, or a diameter of from about 1 μm to about 3 μm.

According to another aspect, a method of isolating a target cell comprises (a) contacting the particle complex with a biological sample including the target cell; (b) isolating the particle complex specifically bound to the target cell; and (c) cleaving the cleavable linker in the particle complex, thereby resulting in a target cell-including moiety and a particle-including moiety.

Each operation of the target cell isolation method will be described in greater detail below.

The method may include contacting the particle complex and the biological sample including the target cell.

The biological sample may be any of a variety of biological samples including the target cell. In some embodiments, the biological sample may be selected from the group consisting of bioptic samples, tissue samples, cell suspensions in liquid media, cell cultures, and a combination thereof. In some other embodiments, the biological sample may be a body fluid of an animal selected from the group consisting of blood, bone marrow liquid, lymph, saliva, lachrymal fluid, urine, mucous membrane fluid, amnoitic fluid, and a combination thereof, but is not limited thereto. For example, for use in the isolation of CTCs, the biological sample may be blood.

The contacting of the particle complex and the biological sample including the target cell may take place in a solution containing the biological sample. This solution may serve as an environment for stable reaction between the biological sample and the particles. The solution may be a buffer solution widely known in the art. Non-limiting examples of the solution are phosphate buffered saline (PBS) and phosphate buffered saline with Tween (PBST).

In some embodiments, the method may further include pre-treating a biological sample to obtain macromolecules and cells before the contacting of the particle complex and the biological sample including the target cell. In some embodiments, the pre-treating may include reducing or removing materials (e.g., biological materials) from the biological sample other than the target cell. The pre-treating may be a process selected from the group consisting of centrifugation, filtration, and chromatography, such as affinity chromatography, and a combination thereof. For example, when the biological sample is blood, blood serum may be removed from the blood via pre-treating, so that only proteins and cells remaining in the blood may be subjected to the above-described contacting step. In some embodiments, the proteins in the blood may be further removed from the blood so that only the cells in the blood may be subjected to the above-described contacting step. The cells may include the target cells and any other cells present in the biological sample.

In some embodiments, the target cells may be selected from the group consisting of CTCs, cancer stem cells, immune cells, fetal stem cells, fetal cells, cancer cells, tumor cells, and a combination thereof.

The target cell isolation method may further include washing to remove the particle complexes remaining unbound with the target cells after the above-described contacting operation.

The washing to remove or reduce the number of unbound particle complexes and, optionally, other substances besides those particle complexes specifically bound to the target cell may be performed by at least one of a flowing washing solution , centrifugation, filtration, and chromatography, and a combination thereof. The washing solution may be selected from the group consisting of water, a buffer solution, such as a PBS, physiological saline, and a combination thereof, but is not limited thereto.

The target cell isolation method may include isolating the particle complex specifically bound to the target cell after the washing.

The isolating of the particle complex may be performed in a variety of ways depending on the type of particles constituting the particle complex. In some embodiments, the isolating of the particle complex may be performed by at least one of centrifugation, filtration, chromatography, magnetic induction, and a combination thereof.

The cleavable linker may be cleaved to release the target cell from the particle complex. When the cleavable linker is a photocleavable compound, the cleaving of the cleavable linker may include radiating light of a specific wavelength onto the particle complex. The wavelength depends on the type of the photocleavable compound. For example, light having a wavelength of about 10 nm to about 400 nm (e.g. 20 nm, 50 nm, 70 nm, 100 nm, 120 nm, 150 nm, 170 nm, 200 nm, 220 nm, 250 nm, 270 nm, 300 nm, 320 nm, 350 nm, or 370 nm and including ranges thereof) and in some other embodiments, light having a wavelength of from about 340 nm to about 370 nm, may be radiated to cleave the cleavable linker.

In some embodiments, the target cell separation method may further include removing the cleaved particle, including any attached portion of the linker, from the composition comprising the target cells after the cleaving operation.

One or more embodiments of the present disclosure will now be described in detail with reference to the following examples. However, these examples are for illustrative purposes only and are not intended to limit the scope of the one or more embodiments of the present disclosure.

### EXAMPLE 1

### Preparation of a Particle Complex for Target Cell Isolation

FIG. 1 is a schematic view of a particle complex for separating a target cell, according to an embodiment. A surface of a particle 70 may be coated with a lubricant such as polyethylene glycol (PEG) 60 in order to prevent non-specific adsorption of macromolecules excluding a target cell 10, having a cleavable linker 50 bound to the surface. A terminal of the cleavable linker 50 may be linked with a macromolecular substance, such as an antibody 30, able to specifically bind to a surface marker 20 of the target cell 10. In some embodiments, the particle complex may be used to isolate the target cell in a biological sample due to the specific binding between the surface marker of the target cell and the macromolecular substance in the particle complex. If the macromolecular substance is an antibody, the particle complex may further include a carrier protein such as Protein G 40 in order to improve binding strengths and orientations of the cleavable linker 50 and the antibody 30.

The target cell to be isolated in the present embodiment was a human breast cancer cell line SKBR3 (available from Korean Cell Line Bank). To prepare the particle complex for target cell isolation, a surface of a melamine bead (available from Fluka) was coated with PEG, and the coated melamine bead was conjugated with carboxylic acid using EDC/NHS at room temperature for about 4 hours. Afterward, a photocleavable compound (see FIG. 1) was bound to the thiol group in 40% DMF. A PBS solution containing 5% BSA was added to the resultant. 0.65 mg/ml of protein G was added thereto and reacted for about 2 hours. Next, human EpCAM/TROP1 Fluorescein MAb ((Clone 158206), FAB9601 F, R&S system) as an antibody specifically binding to EpCAM was added to the reaction solution at a concentration of about 0.65 mg/ml, which was then gently shaken at room temperature for about 2 hours. As a result, a particle complex for breast cancer cell isolation wherein the antibody specifically binding to EpCAM, protein G, and the photocleavable compound are linked together was obtained.

### EXAMPLE 2

Verification of Binding Reaction Between Particle Complex and Breast Cancer Cell for Breast Cancer Cell Isolation

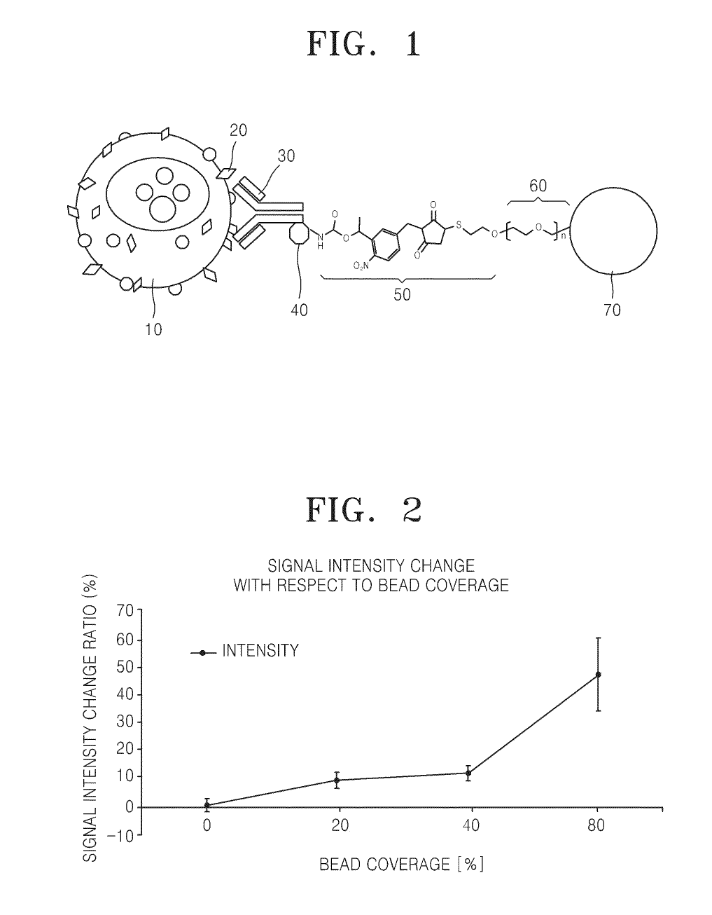

About 0.1 μl, 0.5 μl, 1 μl, 5 μl, and 10 μl of the particle complex for breast cancer cell isolation prepared in Example 1 were added to DMEM media each containing 1×10⁵ floating SK-BR3 breast cancer cells , and then were left for about 1 hour. Each culture product was reacted with R-phycoerythrin (PE)-labeled anti-HER2 antibody (available from BD Bioscience) (20 μg/ml) for about 1 hour, followed by verifying whether the particle complex for breast cancer isolation was bound to the SK-BR3 breast cancer cells based on fluorescence intensities of PE read using a fluorescent microscope (Olympus IX-81). The fluorescence intensity from the cells was found to be increased to such an extent that the surfaces of the breast cancer cells were covered with the particle complex (FIG. 2).

### EXAMPLE 3

Verification of Binding Between Breast Cancer Cells and Particle Complex for Breast Cancer Cell Isolation and Removal of Particles by Exposure to Light, and Fluorescence Intensity Comparison

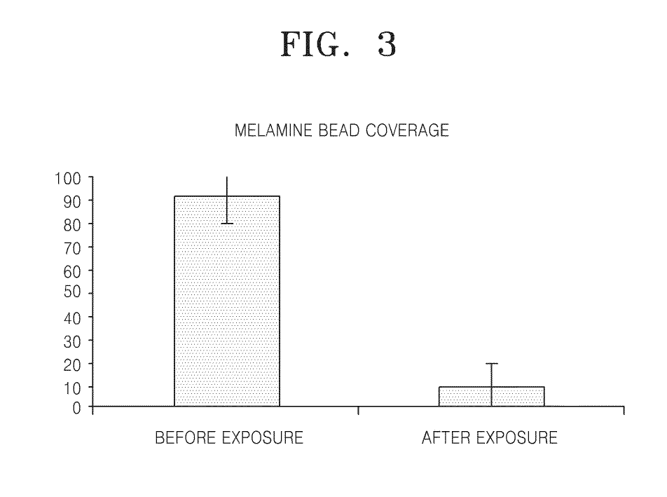

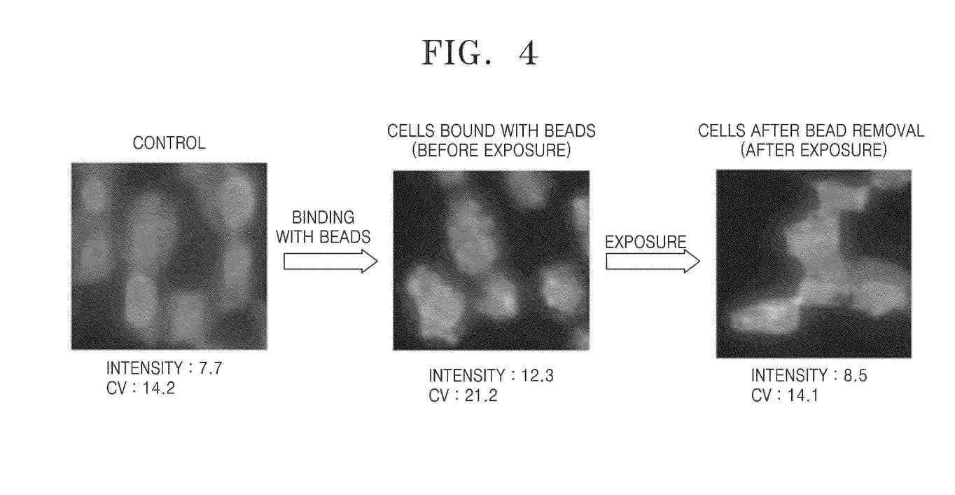

The microscopic images of the particle complex for breast cancer cell isolation and the SK-BR3 cell line obtained in Example 2 were further analyzed to obtain a binding ratio. As a result, it was found that about 90% or more of the cell surface was bound with the particle complex for breast cancer cell isolation. After exposure to light at about 365 nm with an energy of about 20 J/cm2, about 90% or more of the particles were removed from the cells (see FIG. 3). Morphologies of the breast cancer cells were not able to be identified when the cells were bound with the particle complex, but could be identified after the particle complex was removed therefrom by exposure to light (see FIG. 4).

The breast cancer cells bound with the particle complex were found to have a fluorescent intensity that was about 60% higher than a control group of the breast cancer cells unbound with the particle complex (12.3 vs. 7.7), but had nearly the same fluorescence intensity as the control group after the particle was removed therefrom by exposure to light (8.5 vs. 7.7).

As described above, by using a particle complex and a target cell isolation method using the same according to the one or more of the above embodiments, a target cell may be efficiently isolated.

It should be understood that the exemplary embodiments described herein should be considered in a descriptive sense only and not for purposes of limitation. Descriptions of features or aspects within each embodiment should typically be considered as available for other similar features or aspects in other embodiments.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A particle complex comprising:
a particle;
a cleavable linker bound to a surface of the particle; and
a macromolecule bound to the cleavable linker, wherein the macromolecule specifically binds to a surface marker of a target cell.

2. The particle complex of claim 1, wherein the macromolecule is an antibody or an aptamer.

3. The particle complex of claim 1, wherein the cleavable linker comprises a photocleavable compound.

4. The particle complex of claim 3, wherein the photocleavable compound comprises a 2-nitrobenzyle group and a (coumarin-4-yl)methyl group.

5. The particle complex of claim 1, wherein the particle is coated with an anti-adsorption agent.

6. The particle complex of claim 5, wherein the anti-adsorption agent is polyethylene glycol (PEG), bovine serum albumin (BSA), casein, or a serum protein.

7. The particle complex of claim 1, wherein the particle complex further comprises a protein connecting the cleavable linker and the macromolecule, wherein the protein is protein G, protein L, protein A, protein LA, protein AG, or a combination thereof.

8. The particle complex of claim 1, wherein the particle is a polymer particle, silica particle, metal particle, glass particle, magnetic particle, or a particle comprising a combination of polymer, silica, metal, glass, or magnetic materials.

9. The particle complex of claim 1, wherein the target cell is a circulating tumor cells (CTC), cancer stem cell, immune cell, fetal stem cell, fetal cell, cancer cell, or tumor cell.

10. The particle complex of claim 1, wherein the surface marker is a protein, sugar, lipid, nucleic acids, and a combination thereof.

11. The particle complex of claim 1, wherein the particle has a diameter of about 10 nm to about 10 μm.

12. A method of isolating a target cell, the method comprising:
contacting the particle complex of claim 1 with a biological sample including the target cell, wherein the macromolecule of the particle complex specifically binds the target cell ;
isolating the particle complex specifically bound to the target cell from the sample; and
cleaving the cleavable linker of the particle complex.

13. The method of claim 12, wherein the target cell is a circulating tumor cells (CTC), cancer stem cell, immune cell, fetal stem cell, fetal cell, cancer cell, or tumor cell.

14. The method of claim 12, wherein the biological sample is a body fluid of an animal.

15. The method of claim 14, wherein the body fluid comprises blood, bone marrow liquid, lymph, saliva, lachrymal fluid, urine, mucous, amnoitic fluid, or a combination thereof.

16. The method of claim 12, wherein the cleavable linker comprises a photocleavable compound.

17. The method of claim 12, wherein the cleaving of the cleavable linker comprises irradiating light having a wavelength of about 10 nm to about 400 nm to cleave the cleavable linker.

18. The method of claim 12, wherein the method further comprises pre-treating the biological sample to remove a portion of the materials of the biological sample other than the target sample.

19. The method of claim 12, wherein the isolating of the particle complex from the sample is performed by at least one of centrifugation, filtration, chromatography, magnetic induction, or a combination thereof.

20. The method of claim 12, wherein the method further comprises removing the particle from the sample after cleaving the cleavable linker.
